(19) United States
(12) Patent Application Publication
(10) Pub. No.: US 2010/0133168 A1
(43) Pub. Date: Jun. 3, 2010

(54) SEDIMENT CONTROL APPARATUS

(76) Inventors: Ronald E. Jacobsen, Dallas, WI (US); Lois Jacobsen, Dallas, WI (US)

Correspondence Address: LAW OFFICE OF JERRY D. HAYNES , P.A, P.O. Box 350392, Fort Lauderdale, FL, 33335, US

(21) Appl. No.: 12/327,173

(22) Filed: Dec. 3, 2008

(51) Int. Cl. B01D 35/30

(52) U.S. Cl. 210/455

(57) ABSTRACT

Disclosed is a sediment control apparatus capable of trapping sediments carried by a water stream. The apparatus comprises a filter member, a cover member, and a fastening mechanism. The filter member comprises an enclosure member composed of a permeable material capable of allowing water to pass therethrough, and a filtering material stored within the enclosure member for trapping sediments carried by the water stream. The cover member is coupled to the enclosure member such that an intermediate portion of the cover member is received on a portion of the enclosure member, and side portions of the cover member overhang from the enclosure member. The fastening mechanism is adapted to secure the side portions of the cover member to a surface for securing the filter member to the surface. The apparatus may further include at least one skirt portion configured on at least one peripheral edge of the cover member.

### FIELD OF THE INVENTION

The present invention relates generally to erosion control apparatuses, and, more particularly, to a sediment control apparatus to be placed across a water stream for trapping sediments carried by the water stream.

### BACKGROUND OF THE INVENTION

Generally, it has been seen that a water stream, such as a stormwater runoff, causes erosion of surface over which the water stream flows. Sediments formed due to such erosion may, in turn, pollute a waterway, such as a river, a channel, and a canal, into which the water stream flows. More specifically, a water stream flowing over soil in down slopes erodes the soil and carries the eroded soil to the waterway. The eroded soil may get deposited as sediments in the waterway, thereby polluting the waterway. The term “sediments” used herein refers to an impervious material, such as soil particulates, sand, and pebbles, which may be carried by the water steam. Further, the sediments may be carried to a waterway through a waterway system. The term “waterway system” used herein refers to an artificially made water drainage means, such as a storm grate by a roadside, which may be used for channelizing water from land to a waterway. The sediments may get deposited in the waterway system, thereby clogging the waterway system. Moreover, the sediments may be further carried by the water stream to the waterway through the waterway system, thereby polluting the waterway with the sediments.

Various apparatuses for trapping sediments in the water stream are well known in the art. Typically, most of such apparatuses include a filtering element, which filters the water stream for separating the sediments from the water. However, in such apparatuses sediments accumulate under the filtering element, which may runoff due to a high speed or a large volume of the water in the water stream. The sediment runoff under the filtering element may undermine the filtering element. Accordingly, the known apparatuses for trapping sediments in the water stream are not efficient enough to trap the sediments in the water stream, thereby causing the sediments to pollute waterways or clog waterway systems.

Accordingly, there exists a need for a sediment control apparatus for a water stream, which is capable of efficiently trapping sediments carried by the water stream.

### SUMMARY OF THE INVENTION

In view of the foregoing disadvantages inherent in the prior art, the general purpose of the present invention is to provide a sediment control apparatus that is configured to include all the advantages of the prior art, and to overcome the drawbacks inherent therein.

Accordingly, an object of the present invention is to provide a sediment control apparatus which is capable of being placed across a water stream for efficiently trapping sediments carried by the water stream.

In light of the above object, in one aspect of the present invention, a sediment control apparatus is disclosed. The sediment control apparatus comprises a filter member, a cover member, and a fastening mechanism. The filter member is adapted to be placed on a surface. The filter member comprises an enclosure member composed of a permeable material capable of allowing a water stream to pass therethrough, and a filtering material stored within the enclosure member for trapping sediments carried by the water stream. The cover member is coupled to the enclosure member in a manner such that an intermediate portion of the cover member is received on a portion of the enclosure member, and side portions of the cover member overhang from the enclosure member. The cover member is composed of the permeable material. The fastening mechanism is adapted to secure the side portions of the cover member to the surface for securing the filter member to the surface.

In another aspect of the present invention, a sediment control apparatus having at least one skirt portion is disclosed. The sediment control apparatus comprises a filter member, a cover member, the at least one skirt portion and a fastening mechanism. The filter member is adapted to be placed on a surface. The filter member comprises an enclosure member composed of a permeable material capable of allowing a water stream to pass therethrough, and a filtering material stored within the enclosure member for trapping sediments carried by the water stream. The cover member is coupled to the filter member in a manner such that an intermediate portion of the cover member is received on a portion of the enclosure member of the filter member and side portions of the cover member overhang from the enclosure member. The cover member is composed of the permeable material. The at least one skirt portion is configured on at least one peripheral edge of the cover member. The at least one skirt portion extends longitudinally along the filter member from the at least one peripheral edge. The fastening mechanism is adapted to secure the side portions of the cover member and the at least one skirt portion to the surface.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, in which:

FIG. 1 illustrates a perspective view of a sediment control apparatus, in accordance with an exemplary embodiment of the present invention;

FIGS. 2A and 2B illustrate the sediment control apparatus of FIG. 1 being utilized for trapping sediments in a water stream; and

FIG. 3 illustrates a perspective view of a sediment control apparatus, in accordance with another exemplary embodiment of the present invention; and

FIG. 4 illustrates a perspective view of a sediment control apparatus, in accordance with yet another exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in implementation thereof. It should be emphasized, however, that the present invention is not limited to a sediment control apparatus for a water stream, as shown and described. It is understood that various omissions and substitutions of equivalents are contemplated as circumstances may suggest or render expedient, but these are intended to cover the application or implementation without departing from the spirit or scope of the claims of the present invention.

The terms “a” and “an” used herein do not denote a limitation of quantity, but rather denote the presence of at least one of the referenced item.

The present invention provides a sediment control apparatus for a water stream. The sediment control apparatus of the present invention enables in trapping sediments carried by the water stream thereby preventing the sediments from entering a waterway. Further, the sediment control apparatus of the present invention enables in avoiding clogging of a waterway system. The sediment control apparatus may be utilized on shorelines, steep slopes, roadsides, and the like.

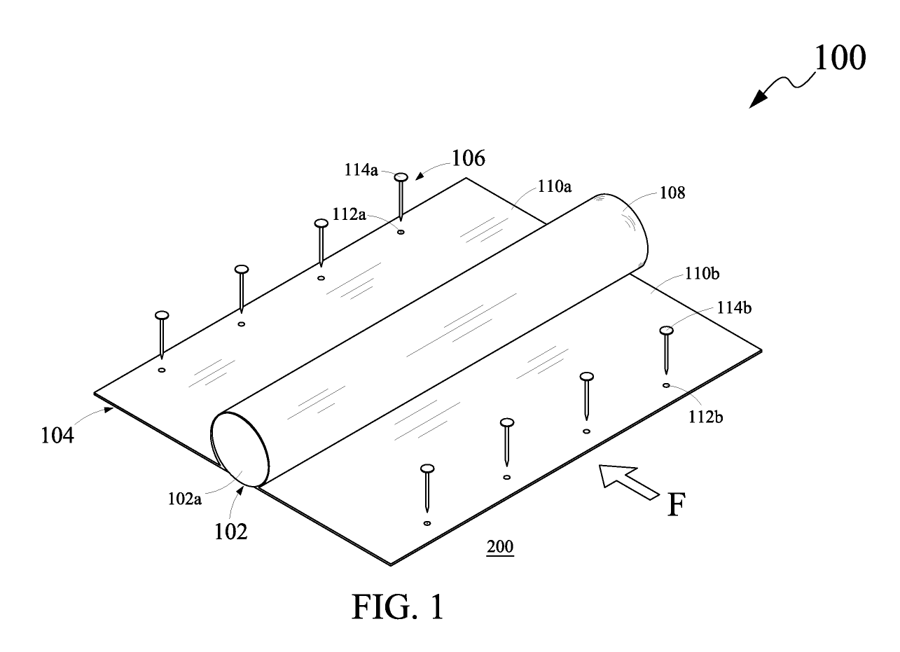

Referring to FIG. 1, a perspective view of a sediment control apparatus 100 (hereinafter referred to as an apparatus 100) is illustrated, in accordance with an exemplary embodiment of the present invention. The apparatus 100 of the present invention may be placed across a water stream (having a flow direction, represented by an arrow ‘F’) for trapping sediments carried by the water stream. The apparatus 100 includes a filter member, such as a filter member 102, adapted to be placed on a surface 200. The term ‘surface’ as used herein refers to a surface over which the water stream may flow. For example, surface may include a bed of a waterway, a surface of a down slope, a surface near a shoreline and the like. The water stream may erode the surface 200 thereby causing formation of sediments that are carried along with the water stream. Accordingly, the apparatus 100 needs to be configured on the surface 200 for trapping sediment which otherwise may be carried by the water stream.

The apparatus 100 further includes a cover member, such as a cover member 104, coupled to the filter member 102, and a fastening mechanism 106 adapted to secure the filter member 102 to the surface 200. The filter member 102 includes a hollow enclosure member 102a (hereinafter referred to as “enclosure member 102a”) and a filtering material (not shown) stored within the hollow enclosure member 102a. In the present embodiment, the filter member 102 is configured to assume a cylindrical structure. More specifically, the enclosure member 102a of the filter member 102 is configured to assume a hollow cylindrical structure with closed ends. It will be evident to a person skilled in the art that the enclosure member 102a may be configured to assume other shapes, such as an elongated hollow elliptical structure, an elongated hollow polygonal structure, and the like. Further, the enclosure member 102a is composed of a permeable material capable of allowing the water stream to pass therethrough when the filter member 102 is placed in the water stream. Specifically, the enclosure member 102a may be composed of a sediment control fabric. In one embodiment of the present embodiment, the sediment control fabric may include at least one of a woven geotextile material, a non-woven geotextile, and combination thereof.

As explained herein, the filtering material is stored within the enclosure member 102a. More specifically, the filtering material occupies a hollow space within the enclosure member 102a. The filtering material enables the enclosure member 102a to filter the water stream passing therethrough by trapping the sediments carried by the water stream. In one embodiment of the present invention, the filtering material may include at least one of wood chips, fibers, mulch, barley, barely straw, cornstarch, cornstalks, and combination thereof. The filtering material described herein is a biodegradable material. However, in another embodiment of the present invention, the filtering material may include polymers, shredded rubber, polyethylene foam, rocks, and a highly permeable coil system which allows a high flow rate of the water stream.

As shown in FIG. 1, the cover member 104 is configured to assume a rectangular sheet like structure. The cover member 104 is coupled to the filter member 102. More specifically, the cover member 104 is coupled to the enclosure member 102a in a manner such that an intermediate portion 108 of the cover member 104 is received on a portion (not shown) of the enclosure member 102a, and side portions, such as side portions 110a and 110b, of the cover member 104 overhang from the enclosure member 102a onto the surface 200. As shown in FIG. 1, the cover member 104 is received on a peripheral surface (not shown) of the enclosure member 102a for longitudinally covering a substantial portion of the enclosure member 102a.

In one embodiment of the present invention, the enclosure member 102a may be coupled to the cover member 104 by sewing together the intermediate portion 108 of the cover member 104 and the peripheral surface of the enclosure member 102a with the help of polyester threads. Further, the cover member 104 is also composed of the permeable material capable of allowing the water stream to pass therethrough. Specifically, the cover member 104 may be composed of the sediment control fabric. In one embodiment of the present embodiment, the sediment control fabric may include at least one of a woven geotextile material, a non-woven geotextile material, and combination thereof. In another embodiment of the present invention, the cover member 104 may be composed a netting material.

As explained herein, the fastening mechanism 106 is adapted to secure the filter member 102 to the surface 200. More specifically, the fastening mechanism 106 is adapted to retain the filter member 102 to the surface 200 by coupling the side portions 110a and 110b of the cover member 104 to the surface 200.

In the present embodiment, the fastening mechanism 106 includes a grommet and peg arrangement. More specifically, the fastening mechanism 106 includes a plurality of grommets, such as grommets 112a and 112b (hereinafter collectively referred to as a plurality of grommets 112), and a plurality of pegs, such as pegs 114a and 114b (hereinafter collectively referred to as a plurality of pegs 114). The plurality of grommets 112 are configured on the side portions 110a and 110b of the cover member 104. The plurality of pegs 114 is capable of being received through the plurality of grommets 112 into the surface 200 for coupling the side portions 110a and 110b of the cover member 104 to the surface 200. In another embodiment of the present invention, the apparatus 100 may include other fastening mechanism apart from the grommet and peg arrangement, such as staples.

In use, the apparatus 100 needs to be configured on the surface 200 in a manner such that the filter member 102 of the apparatus 100 is placed across the water stream having the flow direction ‘F’, as shown in FIG. 1. Accordingly, the water stream may pass through the filter member 102, specifically the enclosure member 102a and the filtering material. The enclosure member 102a and the filtering material trap the sediments carried by the water stream, thereby filtering the water stream. Further, the side portions 110a and 110b of the cover member 104 enable in protecting the filter member 102 from getting damaged by sediments carried by the water stream. In the present embodiment, the side portion 110b of the cover member 104 enables in avoiding the sediments to pass under the filter member 102. More specifically, in one embodiment of the present invention, the side portion 110b of the cover member 104 may be trenched into a portion of the surface 200. For example, a trench of 2 inches by 3 inches may be configured on the portion of the surface 200 and the side portion 110b of the cover member 104 may be disposed on the portion and coupled thereto with the help of the fastening mechanism 106. Accordingly, the side portion 110b of the cover member 104 prevent washout of the sediments over the filter member 102.

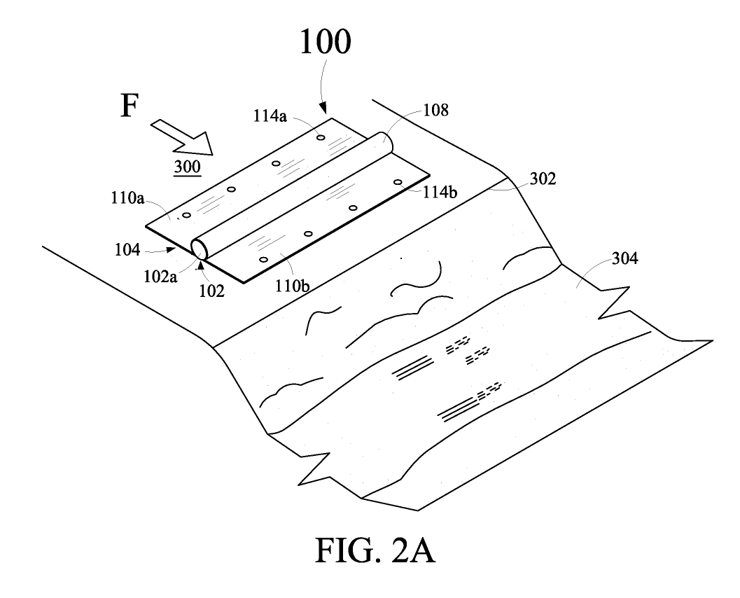

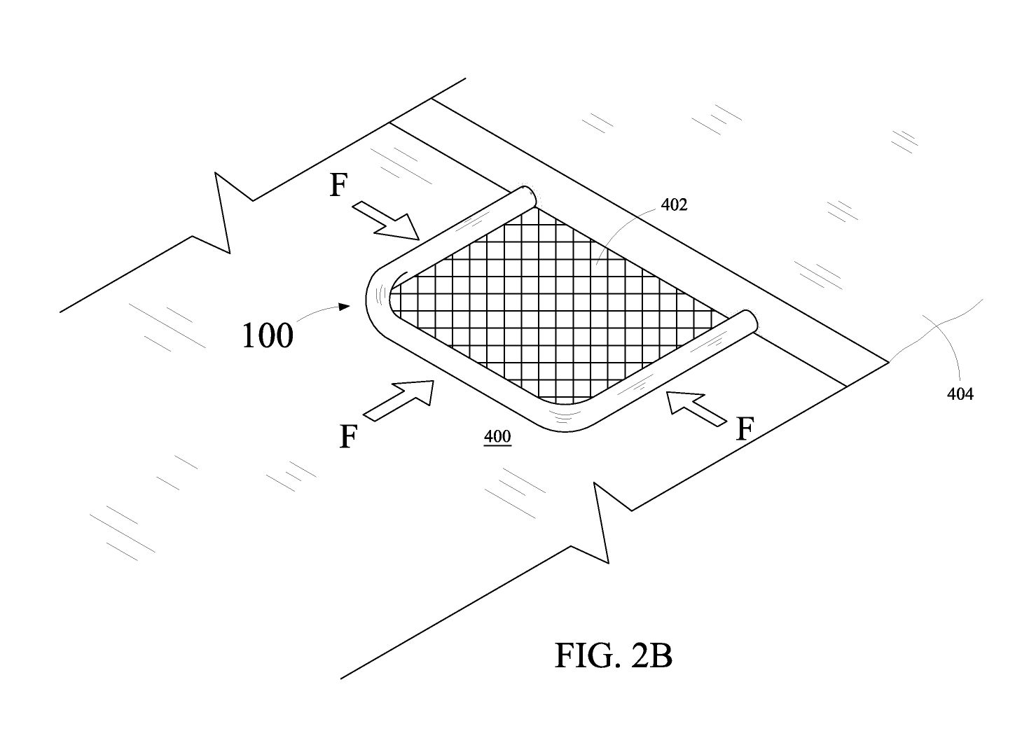

Referring now to FIG. 2A, the apparatus 100 is illustrated to be utilized for controlling sediments in a water stream, in accordance with an exemplary embodiment of the present invention. Specifically, the apparatus 100 is illustrated as being configured on a surface, such as a surface 300. More specifically, the surface 300 is that of a shoreline 302 of a waterway 304. As shown in FIG. 2A, the apparatus 100 is positioned on the surface 300 with the side portions 110a and 110b of the cover member 104 coupled to the surface 300. The plurality of pegs 114 is inserted through the plurality of grommets 112 (as described in FIG. 1), configured on the side portions 110a and 110b, for securing the apparatus 100 to the surface 300.

The apparatus 100 is secured to the surface 300 such that the filter member 102 is placed across a water stream having a flow direction ‘F’. The water stream gets filtered by the filter member 102 (as explained in conjunction with FIG. 1), before crossing the shoreline 302 to enter the waterway 304. Accordingly, the apparatus 100 enables in trapping the sediments carried by the water stream, thereby preventing the sediments from entering the waterway 304 and causing pollution therein.

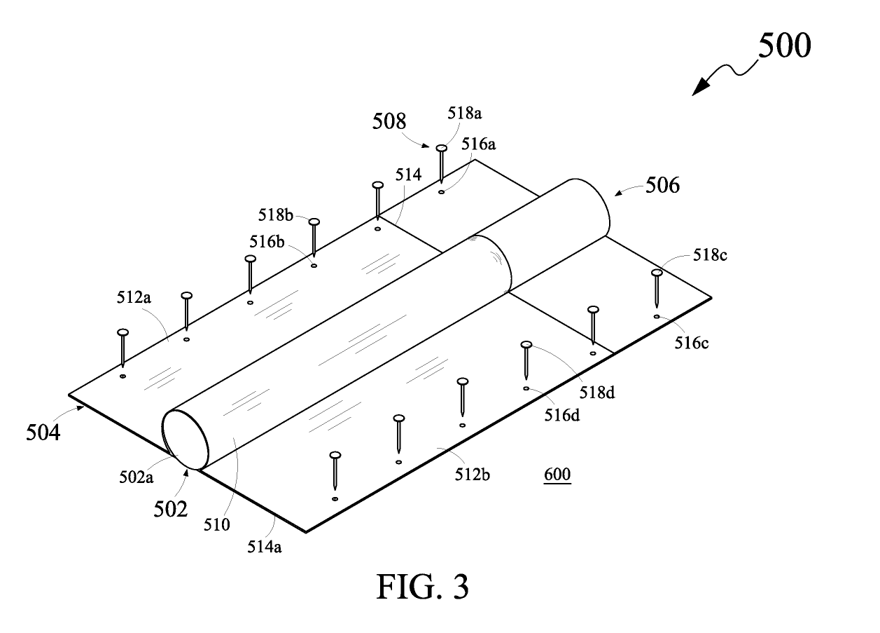

It will be evident to a person skilled in the art that depending on a length of a shoreline, such as the shoreline 302, a plurality of sediment control apparatuses, such as a number of apparatus 100, may be configured along a length of the shoreline for avoiding the sediment from entering a waterway, such as the waterway 304. More specifically, the plurality of sediment control apparatuses may be longitudinally placed and coupled for being configured along the entire length of the shoreline. In one embodiment of the present invention, a cover member, such as the cover member 104 of the apparatus 100, may include a skirt portion which enables in longitudinally coupling the plurality of sediment control apparatuses. The said embodiment of the present invention would be described in detail in conjunction with FIG. 3.

Referring now to FIG. 2B, the apparatus 100 of FIG. 1 is illustrated as being utilized for trapping sediments in a water stream, in accordance with another exemplary embodiment of the present invention. More specifically, the apparatus 100 is configured at a surface 400 adjacent to an inlet, such as a storm grate 402, of a waterway system (not shown) that is configured along a roadside 404. In the present embodiment, the storm grate 402 may be configured on the roadside 404 of a construction site where the possibility of erosion of soil is higher due to a stormwater runoff. As shown in FIG. 2B, the apparatus 100 is bent to configure a U-shaped structure for conforming to a periphery of the storm grate 402. However, it will be apparent to a person skilled in the art that the apparatus 100 may be configured to assume other shapes, such as a circular shape, an elliptical shape, and a polygonal shape, based on a shape of a storm grate.

In the present embodiment, the side portions 110a and 110b (as described in conjunction with FIGS. 1 and 2A) of the cover member 104 is received under the storm grate 402. In the described embodiment, it will be evident to a person skilled in the art that the side portions 110a and 110b of the cover member 104 may not be secured to the surface 400. More specifically, the side portions 100a and 100b of the cover member 104 may be received in a cavity (not shown), under the storm grate 402 and secured to surfaces enclosing the cavity by utilizing the fastening mechanism 106 (as described in conjunction with FIGS. 1 and 2A). Thereafter, the storm grate 402 may be positioned on the cavity with the apparatus 100 surrounding the periphery of the storm grate 402. In another embodiment of the present invention, the side portions 110a and 110b of the cover member 104 may be coupled to the surface 400 around the periphery of the storm grate 402 with the help of the fastening mechanism 106.

In the present embodiment, as shown in FIG. 2B, the apparatus 100 is placed across a water stream having the flow direction ‘F’ such that the apparatus filters the water stream before the water stream enters the storm grate 402. Accordingly, the apparatus 100 enables in trapping the sediments carried by the water stream entering the storm grate 402, thereby preventing clogging of the storm grate 402 which may cause floods by the roadside 404.

Referring now to FIG. 3, a sediment control apparatus 500 (hereinafter referred to as “apparatus 500”) is illustrated, in accordance with another exemplary embodiment of the present invention. The present embodiment enables a plurality of sediment control apparatuses, such as a number of apparatus 500, to be longitudinally coupled for being utilized along long shorelines. The apparatus 500 includes a filter member 502, a cover member 504, at least one skirt portion, such as a skirt portion 506, and a fastening mechanism 508.

The filter member 502 of the apparatus 500 includes an enclosure member 502a, and a filtering material (not shown) stored in the enclosure member 502a. More specifically, in the present embodiment, the structural configuration and functionality of the filter member 502 of the apparatus 500 is similar to the structural configuration and functionality of the filter member 102 of the apparatus 100. Accordingly, a detailed explanation of the filter member 502 of the apparatus 500 has been avoided for sake of brevity.

The cover member 504 is coupled to the filter member 502 in a manner such that an intermediate portion 510 of the cover member 504 is received on a portion of the enclosure member 502a and side portions, such as side portions 512a and 512b, overhang from the enclosure member 502a. Further, in the present embodiment, the structural configuration and functionality of the intermediate portion 510 and the side portions 512a and 512b of the cover member 504 is similar to the structural configuration and functionality of the intermediate portion 108 and the side portions 110a and 110b of the cover member 104. Accordingly, a detailed explanation of the intermediate portion 510 and the side portions 512a and 512b of the cover member 504 has been avoided for sake of brevity.

Referring back to FIG. 3, in the present embodiment, the skirt portion 506 is configured on at least one peripheral edge, such as a peripheral edge 514, of the cover member 504. The skirt portion 506 extends longitudinally along the filter member 502 from the peripheral edge 514. The skirt portion 506 of the apparatus 500 enables in longitudinally coupling the apparatus 500 to an additional sediment control apparatus (not shown), such as the apparatus 500. More specifically, the apparatus 500 and the additional sediment control apparatus may be longitudinally placed in a manner such that a filter member, such as the filter member 502, of the additional sediment control apparatus is received by the skirt portion 506 of the apparatus 500. As shown in FIG. 3, the skirt portion 506 is configured to assume a shape of the cover member 504 enclosing the filter member 502. Accordingly, the skirt portion 506 of the apparatus 500 encloses the filter member of the additional sediment control apparatus thereby enabling in longitudinally coupling the apparatus 500 with the additional sediment control apparatus.

Further, the apparatus 500 and the additional sediment control apparatus may be coupled to a surface, such as a surface 600, by the fastening mechanism 508. In the present embodiment, the fastening mechanism 508 includes a plurality of grommets, such as grommets 516a, 516b, 516c and 516d (hereinafter collectively referred to as a plurality of grommets 516), and plurality of pegs, such as pegs 518a, 518b, 518c, and 518d (hereinafter collectively referred to as a plurality of peg 518). The plurality of grommets 516 is configured on the side portions 512a and 512b of the cover member 504, and skirt portion 506 of the apparatus 500. More specifically, as shown in FIG. 3, the grommets 516b and 516d are configured on the side portions 512a and 512b, respectively, of the cover member 504 and the grommets 516a and 516c are configured on the skirt portion 506. The plurality of pegs 518 are capable of being received through the plurality of grommets 516 into the surface 600 for securing the side portions 512a and 512b, and skirt portion 506 to the surface 600. Accordingly, the apparatus 500 and the additional sediment control apparatus may be longitudinally coupled to the surface 600 by the fastening mechanism 508.

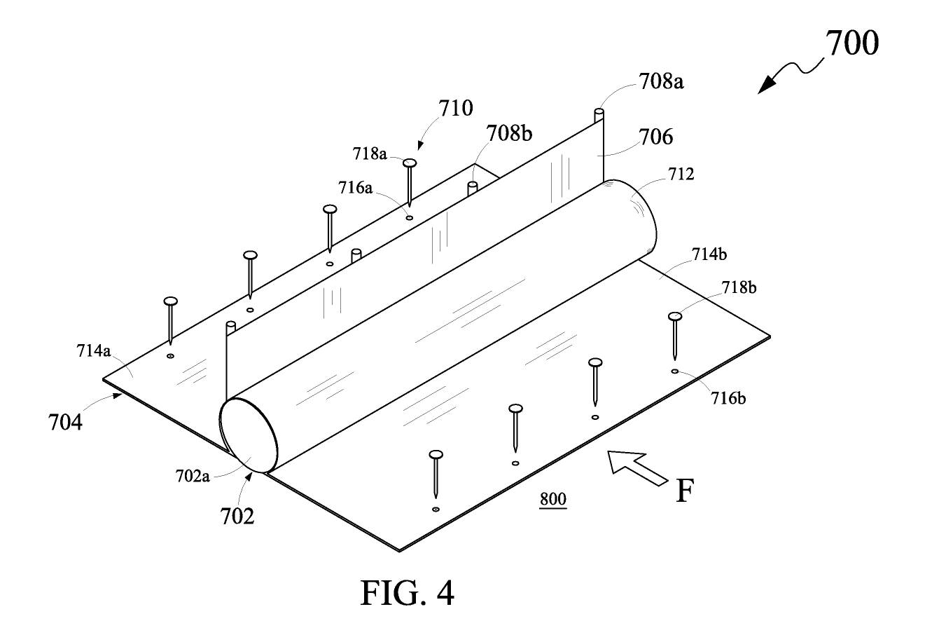

Referring now to FIG. 4, a sediment control apparatus 700 (hereinafter referred to as “apparatus 700”) is illustrated, in accordance with yet another exemplary embodiment of the present invention. The apparatus 700 of the present invention is capable of being utilized on a high flow situation. The term ‘high flow situation’ used herein refers a high level of water in the water stream. The apparatus 700 includes a filter member 702, a cover member 704, a skirt projection 706, a plurality of stakes, such as stakes 708a and 708b, and a fastening mechanism 710.

The filter member 702 of the apparatus 700 includes an enclosure member 702a, and a filtering material (not shown) stored in the enclosure member 702a. In the present embodiment, the structural configuration and functionality of the filter member 702 of the apparatus 700 is similar to the structural configuration and functionality of the filter member 102 of the apparatus 100. Accordingly, a detailed explanation of the filter member 702 of the apparatus 700 has been avoided for sake of brevity.

The cover member 704 is coupled to the filter member 702 in a manner such that an intermediate portion 712 of the cover member 704 is received on a portion of the enclosure member 702a, and side portions, such as side portions 714a and 714b, overhang from the enclosure member 702a. Further, in the present embodiment, the structural configuration and functionality of the intermediate portion 712, and the side portions 714a and 714b of the cover member 704 is similar to the structural configuration and functionality of the intermediate portion 108, and the side portions 110a and 110b of the cover member 104 of the apparatus 100. Accordingly, a detailed explanation of the intermediate portion 712 and the side portions 714a and 714b of the cover member 704 has been avoided for sake of brevity.

The fastening mechanism 710 is adapted to secure the side portions 714a and 714b of the cover member 704 to a surface 800 for securing the filter member 702 of the apparatus 700 to the surface 800. The fastening mechanism 710 includes a plurality of grommets, such as grommets 716a and 716b, configured on the side portions 714a and 714b, and a plurality of pegs, such as pegs 718a and 718b, capable of being received through the grommets 716a and 716b. Further, in the present embodiment, the structural configuration and functionality of the grommets 716a and 716b, and pegs 718a and 718b of the fastening mechanism 710 is similar to the structural configuration and functionality of the grommets 112a and 112b, and pegs 114a and 114b of the fastening mechanism 106. Accordingly, a detailed explanation of the grommets 716a and 716b, and pegs 716a and 716b of the fastening mechanism 710 has been avoided for sake of brevity.

As shown in FIG. 3, the skirt projection 706 is configured on the cover member 704 and extends upwardly therefrom. More specifically, the skirt projection 706 is coupled to the cover member 706 and extends upwardly therefrom with the help the stakes 708a and 708b. In one embodiment of the present invention, the skirt projection 706 is coupled to a portion, separating the side portion 714a and the intermediate portion 712, of the cover member 704. Further, in the present embodiment, the stakes 708a and 708b is coupled to the skirt projection 706 for supporting the skirt projection 706 in a vertically upward position. More specifically, the stakes 708a and 708b are inserted through the cover member 702 into the surface 800 for retaining the skirt projection 706 in the vertically upward position. The utilization of the stakes 708a and 708b further enables in rigidly securing the filer member 702 to the surface 800. In one embodiment of the present invention, the stakes 708a and 708b are coupled to the skirt projection 706 by means of stitches.

The skirt projection 706 is composed on a sediment control fabric. The sediment control fabric may include at least one of a woven geotextile material, a non-woven geotextile material, and combination thereof. Further, the stakes 708a and 708b may be composed of a wooden material or metal. As explained herein, the apparatus 700 is capable of being utilized on the high flow situation. For example, the apparatus 700 may be placed across a water stream (having a flow direction, represented by an arrow ‘F’) for trapping sediments carried by the water stream having the high flow situation. More specifically, when a level of water in the water stream is higher, such that the water stream may flow over the filter member 702 of the apparatus 700. Therefore, in use, the skirt projection 706, supported vertically upward across the water stream having flow direction ‘F’, allow the water stream to pass through the skirt projection 706 for trapping the sediment which may flow over the filter member 702 of the apparatus 700. Accordingly, the apparatus 700 enables in trapping the sediment form the water stream having high level of water.

The sediment control apparatus, as described herein, is subject to many variations. In an exemplary embodiment of the present invention, an enclosure member, such as the enclosure member 102a and the enclosure member 502a, l have a diameter of about 6 inches to about 20 inches. A cover member, such as the cover member 104 and the cover member 504, may have a length of about 17 inches to about 36 inches, and a width of about 8 inches to about 16 inches. Further, a sediment control apparatus, such as the apparatus 500, may include a skirt portion, such as the skirt portion 506, having a length of about 14 inches. Furthermore, the apparatus 500 may include an addition skirt portion (not shown), similar to the skirt portion 506, configured on a peripheral edge, opposite to the peripheral edge 514 (as shown in FIG. 3), of the cover member 504. Moreover, a distance between two adjacent grommets, configured on side portions, such as the side portions 110a and 110b, and the side portions 512a and 512b, of the cover member 104 and the cover member 504, respectively, may be about 1 inch to about 2 inches. Additionally, a distance between adjacent grommets (not shown) configured on the skirt portion 506 of the apparatus 500 may be about 6 inches.

In another embodiment of the present invention, a plurality of sediment control apparatuses, such as a number of apparatus 100, may be coupled in a height-wise manner to configure a retaining wall system. More specifically, based on a level of water in a water stream, the plurality of apparatuses may be coupled in the height-wise manner such that the retaining wall system is capable of avoiding an overflow of the water stream over the retaining wall system.

The sediment control apparatus, as explained herein, enables in efficiently trapping the sediment in a water stream entering a waterway or a waterway system, thereby preventing pollution in the waterway and clogging of waterway system. Specifically, the side portions of the cover member enable in avoiding the sediment to pass under the enclosure member and prevent washout of the sediment. The sediment control apparatus may be easily configurable on a surface with the help of the fastening mechanism, such as a grommet and peg arrangement. Further, the sediment control apparatus is light weight and portable.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A sediment control apparatus comprising:
a filter member adapted to be placed on a surface, the filter member comprising
an enclosure member composed of a permeable material capable of allowing a water stream to pass therethrough, and
a filtering material stored within the enclosure member for trapping sediments carried by the water stream;
a cover member coupled to the enclosure member in a manner such that an intermediate portion of the cover member is received on a portion of the enclosure member, and side portions of the cover member overhang from the enclosure member, the cover member being composed of the permeable material; and
a fastening mechanism adapted to secure the side portions of the cover member to the surface for securing the filter member to the surface.

2. The apparatus of claim 1, wherein the permeable material is a sediment control fabric.

3. The apparatus of claim 2, wherein the sediment control fabric is at least one of a woven geotextile material, a non-woven geotextile, and combination thereof.

4. The apparatus of claim 1, wherein the filter member is configured to assume a cylindrical structure.

5. The apparatus of claim 1, wherein the fastening mechanism comprises:
a plurality of grommets configured on the side portions of the cover member; and
a plurality of pegs capable of being received through the plurality of grommets into the surface for coupling the side portions of the cover member to the surface.

6. A sediment control apparatus comprising:
a filter member adapted to be placed on a surface, the filter member comprising
an enclosure member composed of a permeable material capable of allowing a water stream to pass therethrough, and
a filtering material stored within the enclosure member for trapping sediments carried by the water stream;
a cover member coupled to the filter member in a manner such that an intermediate portion of the cover member is received on a portion of the enclosure member of the filter member and side portions of the cover member overhang from the enclosure member, the cover member being composed of the permeable material;
at least one skirt portion configured on at least one peripheral edge of the cover member, the at least one skirt portion extending longitudinally along the filter member from the at least one peripheral edge; and
a fastening mechanism adapted to secure the side portions of the cover member and the at least one skirt portion to the surface.

7. The apparatus of claim 6, wherein the permeable material is a sediment control fabric.

8. The apparatus of claim 7, wherein the sediment control fabric is at least one of a woven geotextile material, a non-woven geotextile, and combination thereof.

9. The apparatus of claim 6, wherein the filter member is configured to assume a cylindrical structure.

10. The apparatus of claim 6, wherein the fastening mechanism comprises:
a plurality of grommets configured on the side portions and the at least one skirt portion of the cover member; and
a plurality of pegs capable of being received through the plurality of grommets into the surface for coupling the side portions and the at least one skirt portion of the cover member to the surface.
